(19) United States
(12) Patent Application Publication
(10) Pub. No.: US 2010/0012564 A1
(43) Pub. Date: Jan. 21, 2010

(54) DEVICE FOR HOLDING AND SEPARATING CHIPPINGS AND COOLING LIQUID ACCUMULATING ON MACHINE TOOLS (CONVEYANCE)

(75) Inventors: Wiel E.H. Kroonen, Bocholtz (NL); Rene M. Sieben, Sittard (NL); Rimmond H.B. Souren, Meersen (NL); Wilhelmus J.C. Welten, Sittard (NL)

Correspondence Address: CALFEE HALTER & GRISWOLD, LLP, 800 SUPERIOR AVENUE, SUITE 1400, CLEVELAND, OH, 44114, US

(73) Assignee: Mayfran International B.V.

(21) Appl. No.: 11/631,435

(22) PCT Filed: Jul. 1, 2005
(86) PCT No.: PCT/EP2005/007123

§ 371 Date: Sep. 29, 2009

(30) Foreign Application Priority Data
Jul. 2, 2004 (DE) 102004032334.8

(51) Int. Cl. B23Q 11/10; B23Q 11/00

(52) U.S. Cl. 210/171

(57) ABSTRACT

The invention relates to a device for holding and separating chippings and cooling liquid accumulating on machine tools, comprising: a holding tank (1) for holding the chippings and cooling liquid; a guide section (2); a discharge section (3), a chain-like closed conveying element (4), which is guided over return elements of which at least one is coupled to a rotating drive, and; a rotationally mounted filter drum (9) that is drive-connected to the conveying element. A covering element (11), which is invertedly channeled and which is parallel to the axis of the filter drum, is mounted in a fixed manner in the lower area of the filter drum (9), and extends at least over a portion of the length of the filter drum (9). The covering element (11) sealingly communicates, at its one end, with an opening in one wall of the drum housing, and the opening is connected to a suction line (17) that, in turn, is connected to a suction element (18), which is situated at a higher level and which discharges into a collection tank (19).

The invention relates to a device for holding and separating chippings and cooling liquid accumulating on machine tools, the cooling liquid being returned for reuse and the chippings being removed, comprising a holding tank for holding the chippings and the cooling liquid, a rising guide section, adjoining the holding tank, an elevated discharge section, adjoining the guide section, a chain-like closed conveying element, which is guided over return elements, at least in the region holding the chippings and the cooling liquid and in the discharge section, at least one of which elements is coupled to a rotary drive, and a rotatably mounted filter drum, which is in drive connection with the conveying element.

Such a device is known from German patent application 102 23 290.3. Also, a similar device is disclosed in GB 2 302 818. This document describes a device for holding and separating chippings and cooling liquid accumulating on machine tools, comprising a rotating drum filter. Fixedly arranged in the lower region of the filter drum in that case is an inlet tube, which runs parallel to the axis of said filter drum and extends at least over part of the length of the latter. Said inlet tube is in turn connected to a suction tube, which enters the filter drum through the axis thereof and is connected outside to a pump. This arrangement allows filtered liquid to be sucked out from the interior of the filter drum. It is further provided to return part of the sucked-out filtered liquid into the drum and apply it to the wall by means of spray nozzles in the upper region of the drum, in order in this way to flush away residues adhering to the outside.

The invention is based on the object of developing a device of the generic type in such a way that in particular the space requirement that is required altogether for the device is considerably reduced.

This object is achieved in the case of a device of the type mentioned at the beginning by fixedly arranging in the lower region of the filter drum an invertedly channel-shaped covering element, which runs parallel to the axis of said filter drum and extends at least over part of the length of the latter, by the covering element communicating in a sealing manner at its one end with an opening in one wall of the drum housing, and by the opening being connected to a suction line, which is in connection with a suction element, which is arranged at a higher level and discharges into a collection tank.

The cooling liquid which enters the filter drum and is thereby cleaned is passed through an opening in the side wall and then fed via a suction line to a pump, from which the cleaned cooling liquid is directed to a collection tank. This upward conveyance of the cleaned cooling liquid therefore passes close by a side wall of the drum housing and partly also above this housing, so that the entire standing area of the device can be made very small.

According to the invention, it is further provided that the side walls of the covering element reach close to the inner surface of the filter drum, so that the space underneath the covering element is at least partly restricted at its side edges. Consequently, the suction pressure exerted by the pump via the suction line acts in particular in the region enclosed by the covering element.

Further advantageous features of the invention are stated in particular in the claims and are supported by the description.

An exemplary embodiment of the device according to the invention is described below on the basis of drawings, in which:

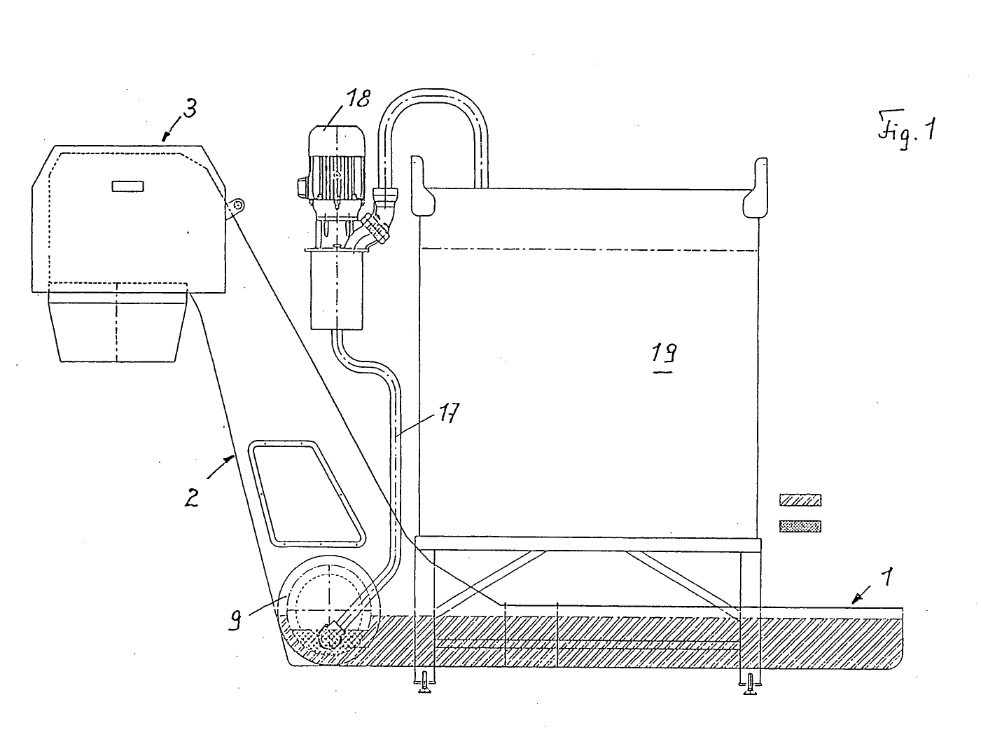

FIG. 1 shows a side view of an embodiment of the device according to the invention,

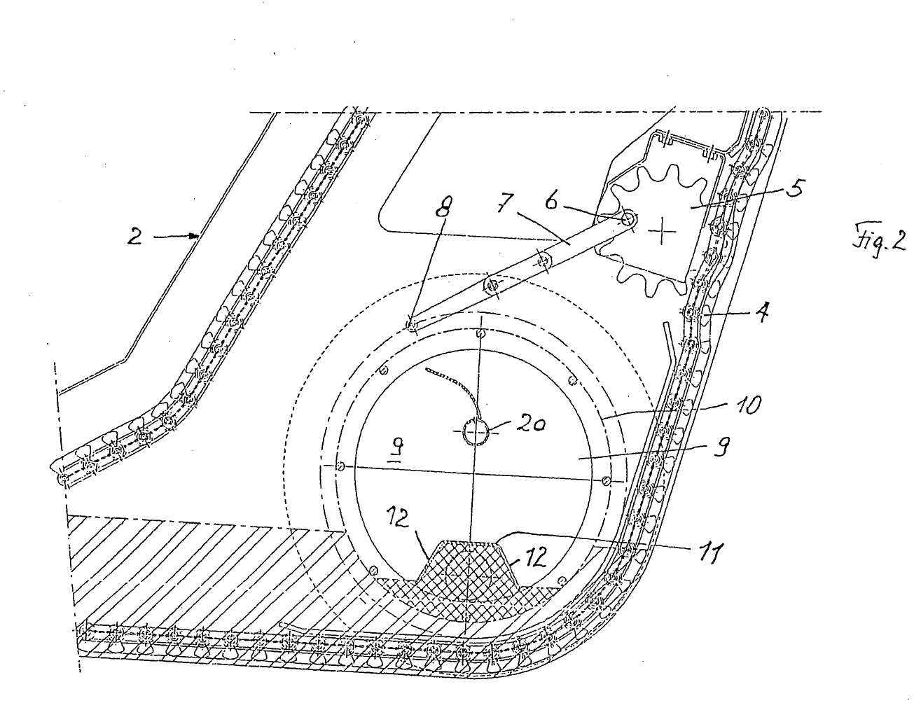

FIG. 2 shows a cross section through the filter drum of the device and

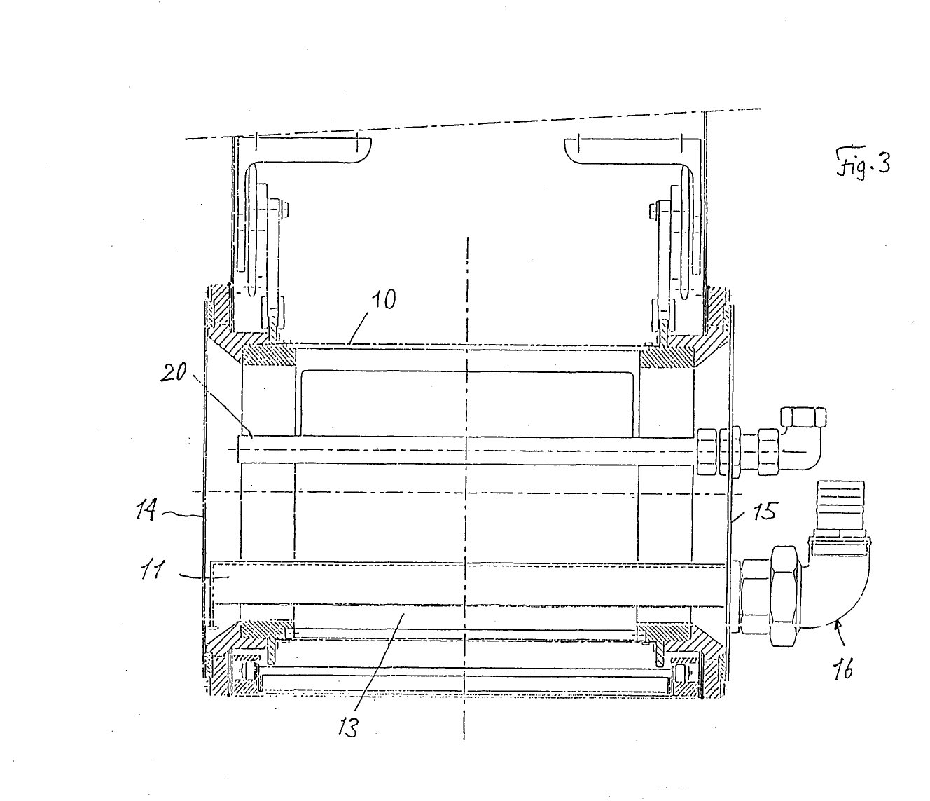

FIG. 3 shows a vertical axial section through the filter drum.

The device according to the invention that is schematically represented in FIG. 1 has a holding tank 1, which is at least partly open in the upward direction and holds chippings and cooling liquid accumulating on machine tools. The holding tank 1 is adjoined by a rising guide section 2, which goes over into an elevated discharge section 3.

Provided for conveying the chippings in the exemplary embodiment shown is a scraper chain 4 (represented in FIG. 2), which is guided over a number of return elements and conveys the chippings from the holding tank 1 to the discharge point in the discharge section 3.

In the exemplary embodiment according to FIG. 2, a gear wheel 5 engages in the scraper chain 4 on the inside. The gear wheel 5 is thereby set in rotation and takes with it a crank pin 6, which acts via a push rod 7 on a ratchet wheel 8 and drives a filter drum 9 intermittently or with changing rotational speeds.

The filter drum 9 is provided on its circumference with a covering 10 (FIG. 2), which acts like a screen on the liquid made to pass by it in its lower region and consequently allows filtered, and consequently precleaned, liquid to enter into the interior of the filter drum 9. In the lower region of the filter drum 9, provided centrally in this drum is a covering element 11, which is formed in an invertedly trough-like manner and the side walls 12 of which therefore slope away from each other in the direction of the inner surface 13 of the inner periphery of the filter drum 9.

The covering element 11 is fixedly supported at its end lying on the left in FIG. 3 on the wall 14 and runs through the entire filter drum 9 to the opposite housing wall 15. However, it may also be expedient to make the covering element 11 end at its end lying on the left at a distance from the left-hand side wall. Provided in any case in the right-hand housing wall 15 is an opening, which by means of bolts and connecting pieces 16 forms a sealed connection between the region underneath the covering element 11 on the one hand and a suction tube 17 on the other hand (FIG. 3). The suction tube 17 is led upward outside the filter drum 9 and close to the drum wall to a suction pump 18, which for its part directs the cooling water cleaned in this way into a collection tank 19, which is placed above the holding tank 1. The suction tube 17 thereby runs in an expedient way partly above the guide section 2 over the latter, so does not laterally protrude there from it.

Furthermore, it is provided that a tube 20, which is provided with jet openings and the free end of which is closed in the region of the filter drum 9, is fixed on the side wall 14 of the filter drum 9. This tube 20 serves the purpose of directing cleaned cooling water in a jet-like manner against the covering of the filter drum 9, in order to blast the covering 10 from the inside and dislodge contaminants situated on the outside of the filter drum 9.

List of Designations

1 holding tank

2 guide section

3 discharge section

4 scraper chain

5 gear wheel

6 crank pin

7 push rod

8 ratchet wheel

9 filter drum

10 covering

11 covering element

12 side wall

13 inner surface

14 wall

15 housing wall

16 connecting piece

17 suction tube

18 suction pump (suction element)

19 collection tank

20 backflush tube

1. A device for holding and separating chippings and cooling liquid accumulating on machine tools, the cooling liquid being returned for reuse and the chippings being removed,
comprising a holding tank (1) for holding the chippings and the cooling liquid,
a rising guide section (2), adjoining the holding tank (1),
an elevated discharge section (3), adjoining the guide section (2),
a chain-like closed conveying element (4), which is guided over return elements, at least in the region holding the chippings and the cooling liquid and in the discharge section (3), at least one of which elements is coupled to a rotary drive, and
a rotatably mounted filter drum (9), which is in drive connection with the conveying element,
an invertedly channel-shaped covering element (11), which runs parallel to the axis of said filter drum (9) and extends at least over part of the length of the latter, being fixedly arranged in the lower region of the filter drum (9),
and the covering element (11) communicating in a sealing manner at its one end with an opening in one wall of the drum housing, and
the opening being connected to a suction line (17), which is in connection with a suction element (18), which is arranged at a higher level and discharges into a collection tank (19).

2. The device as claimed in claim 1, characterized in that the suction element has a venturi insert.

3. The device as claimed in claim 1 or 2, characterized in that the side walls (12) of the covering element (11) reach close to the inner surface of the filter drum (9).

4. The device as claimed in one of the preceding claims, characterized in that the covering element (11) runs under the axis of the filter drum (9) parallel to the latter.

5. The device as claimed in one of the preceding claims, characterized in that the opening in one wall (14) of the filter drum (9) is arranged centrally in relation to the profile of the covering element (11).

6. The device as claimed in one of the preceding claims, characterized in that a backflush tube (20), which is led through the wall (14) of the filter drum in a sealing manner and is connected to a pump, runs above the axis of the filter drum (9).
